(19) United States
(12) Patent Application Publication
(10) Pub. No.: US 2026/0184955 A1
(43) Pub. Date: Jul. 2, 2026

(54) COATING COMPOSITIONS AND METHODS OF COATING

(71) Applicant: Liquid Liner Holdings, LLC, Twinsburg, OH (US)

(72) Inventors: Tyler Dunagin, Twinsburg, OH (US); Evan Bunch, Twinsburg, OH (US); Austen Smith, Twinsburg, OH (US); Ryan Vodicka, Twinsburg, OH (US)

(21) Appl. No.: 19/434,705

(22) Filed: Dec. 29, 2025

Related U.S. Application Data
(60) Provisional application No. 63/740,021, filed on Dec. 30, 2024.

(51) Int. Cl. C09D 163/00; C08G 59/24; C08G 59/50; C08G 59/62; C08K 3/22; C08K 3/26; C09D 7/61

(52) U.S. Cl. CPC C09D 163/00; C08G 59/245; C08G 59/5026; C08G 59/5033; C08G 59/621; C08K 3/26; C09D 7/61; C08K 2003/2227; C08K 2003/265

(57) ABSTRACT

The present disclosure provides systems and compositions for coating surfaces, and methods of coating. In an aspect, the disclosure provides a system comprising component A and component B, which, when mixed, provides a curable mixture which may coat surfaces such as, e.g., wash basin surfaces, and cure thereon to produce a smooth, durable, adherent surface, which protects and renews the basin. Also provided herein are coating compositions, and methods of coating a surface.

### CROSS REFERENCE TO RELATED APPLICATIONS

This application claims the benefit of priority to U.S. Provisional Application 63/740,021, filed Dec. 30, 2024, the contents of which are incorporated herein by reference in their entirety.

### FIELD

Provided herein are coating compositions. Further provided are methods of coating.

### BACKGROUND

Worn and/or stained white washroom fixtures may be replaced with new ceramic, but these can be very expensive. Alternatively, old fixtures may be swapped for synthetic materials such as fiberglass or acrylic polymer fixtures, but these alternatives come with various drawbacks, including that they often look and feel cheap and flimsy. Existing coating products for restoring washroom fixtures lack sufficient cover, bond, and/or durability.

Accordingly, there is an unmet need for safe, effective, durable, smooth, and easy-to-use compositions for coating washroom fixture materials, and methods of coating such materials. The present disclosure addresses such needs.

### SUMMARY

The present invention relates broadly to coating compositions and methods of coating.

In an aspect, the present disclosure provides a curable coating system, the system comprising: a first composition and a second composition, the first composition comprising: a bisphenol A-epoxide polymer, a siloxane polymer, optionally a hydroxide salt, and a carbonate salt; and the second composition comprising: a first cyclic diamine, a second cyclic diamine, a phenol, and an alcohol different from the phenol comprising one or more aromatic groups, wherein mixing the first composition with the second composition causes the combined mixture to cure. In an embodiment, the first composition further comprises an epoxidized oil. In an embodiment, mixing the first composition with the second composition at a relative volumetric ratio ranging from 30:70 to 70:30 causes the combined mixture to cure. In any embodiment, mixing the first composition with the second composition at a relative volumetric ratio of about 50:50 causes the combined mixture to cure. In any of the disclosed embodiments, the hydroxide salt is optionally added.

In an embodiment of the curable coating system, the bisphenol A-epoxide polymer is bisphenol A epichlorohydrin polymer. In an embodiment, the siloxane polymer is a polydimethylsiloxane. In an embodiment, the polydimethylsiloxane is polyalkyleneoxide modified polydimethylsiloxane. In an embodiment, the hydroxide salt is aluminum hydroxide. In an embodiment, the carbonate salt is calcium carbonate. In an embodiment, the first cyclic diamine is isophorone diamine. In an embodiment, the second cyclic diamine is 1,3-benzenedimethanamine. In an embodiment, the phenol is nonylphenol. In an embodiment, the alcohol different from the phenol comprising one or more aromatic groups is benzyl alcohol. In an embodiment, the epoxidized oil is epoxidized soybean oil. In an embodiment, the epoxidized soybean oil is 100%-epoxidized soybean oil.

In any embodiment, the first composition may comprise: 20 v/v % to 45 v/v % bisphenol A-epoxide polymer, 0.2 v/v % to 0.4 v/v % siloxane polymer, 4 v/v % to 8 v/v % hydroxide salt, and 55 v/v % to 80 v/v % carbonate salt. In an embodiment, the first composition comprises: 25 v/v % to 35 v/v % bisphenol A-epoxide polymer, 0.25 v/v % to 0.35 v/v % siloxane polymer, 5 v/v % to 7 v/v % hydroxide salt, and 64 v/v % to 76 v/v % carbonate salt. In an embodiment, the first composition comprises: about 29 v/v % bisphenol A-epoxide polymer, about 0.20 v/v % to 0.40 v/v % siloxane polymer, about 6 v/v % hydroxide salt, and about 65 v/v % carbonate salt.

In an embodiment, the second component may comprise: 15 v/v % to 45 v/v % first cyclic diamine, 8 v/v % to 22 v/v % second cyclic diamine, 18 v/v % to 40 v/v % phenol, and 15 v/v % to 30 v/v % alcohol different from the phenol comprising one or more aromatic groups. In an embodiment, the second component comprises: 25 v/v % to 35 v/v % first cyclic diamine, 12 v/v % to 18 v/v % second cyclic diamine, 22 v/v % to 32 v/v % phenol, and 20 v/v % to 25 v/v % alcohol different from the phenol comprising one or more aromatic groups. In an embodiment, the second component comprises: about 33 v/v % first cyclic diamine, about 17 v/v % second cyclic diamine, about 28 v/v % phenol, and about 22 v/v % alcohol different from the phenol comprising one or more aromatic groups.

In an embodiment, the first component comprises 3 v/v % to 8 v/v % epoxidized oil. In an embodiment, the first component comprises 4 v/v % to 7 v/v % epoxidized oil. In an embodiment, the first component comprises about 6 v/v % epoxidized oil. In an embodiment, the first component further comprises one or more pigments. In an embodiment, the first component comprises about 2 v/v % TiO₂. In an embodiment, the first component comprises about 0.002 v/v % CuCr₂O₄.

In an embodiment, the second component comprises amine-epoxy resin adduct.

In another aspect, the present disclosure provides a coating composition comprising a liquid mixture comprising a bisphenol A-epoxide polymer, a siloxane polymer, a hydroxide salt, a carbonate salt, at least one cyclic diamine, a phenol, and an alcohol different from the phenol comprising one or more aromatic groups. In any embodiment of the coating composition, the composition may further comprise an epoxidized oil.

In an embodiment, the liquid mixture comprises: 10 v/v % to 30 v/v % bisphenol A-epoxide polymer, 0.10 v/v % to 1 v/v % siloxane polymer, 1 v/v % to 8 v/v % hydroxide salt, 20 v/v % to 50 v/v % carbonate salt, 10 v/v % to 30 v/v % at least one cyclic diamine, 4 v/v % to 14 v/v % phenol, and 4 v/v % to 14 v/v % alcohol different from the phenol comprising one or more aromatic groups. In an embodiment, the liquid mixture comprises: 16 v/v % to 24 v/v % bisphenol A-epoxide polymer, 0.20 v/v % to 0.40 v/v % siloxane polymer, 3 v/v % to 5 v/v % hydroxide salt, 35 v/v % to 45 v/v % carbonate salt, 14 v/v % to 18 v/v % at least one cyclic diamine, 6 v/v % to 12 v/v % phenol, and 5 v/v % to 11 v/v % alcohol different from the phenol comprising one or more aromatic groups. In an embodiment, the liquid mixture comprises: 20 v/v % to 21 v/v % bisphenol A-epoxide polymer, 0.26 v/v % to 0.34 v/v % siloxane polymer, 4.2 v/v % to 4.8 v/v % hydroxide salt, 39 v/v % to 41 v/v % carbonate salt, 16.5 v/v % to 17.5 v/v % at least one cyclic diamine, 9 v/v % to 10 v/v % phenol, and 7 v/v % to 8 v/v % alcohol different from the phenol comprising one or more aromatic groups.

In an embodiment, the liquid mixture further comprises about 1 v/v % to 5 v/v % epoxidized oil. In an embodiment, the liquid mixture further comprises about 2 v/v % to 4 v/v % epoxidized oil. In an embodiment, the liquid mixture further comprises about 3 v/v % epoxidized oil.

In an embodiment, the at least one cyclic diamine comprises two different species of cyclic diamine. In an embodiment, the bisphenol A-epoxide polymer is bisphenol A epichlorohydrin polymer. In an embodiment, the siloxane polymer is a polydimethylsiloxane. In an embodiment, the polydimethylsiloxane is polyalkyleneoxide modified polydimethylsiloxane. In an embodiment, the hydroxide salt is aluminum hydroxide. In an embodiment, the carbonate salt is calcium carbonate. In an embodiment, the at least one cyclic diamine comprises isophorone diamine. In an embodiment, the at least one cyclic diamine comprises 1,3-benzenedimethanamine. In an embodiment, the phenol is nonylphenol. In an embodiment, the epoxidized oil is epoxidized soybean oil. In an embodiment, the epoxidized soybean oil is 100%-epoxidized soybean oil. In an embodiment, the alcohol different from the phenol comprising one or more aromatic groups is benzyl alcohol. In an embodiment, the composition further comprises amine-epoxy resin adduct. In an embodiment, the composition further comprises titanium dioxide.

In an embodiment, the titanium dioxide comprises between 18 v/v % and 26 v/v % of the composition. In an embodiment, the titanium dioxide comprises between 20 v/v % and 24 v/v % of the composition. In an embodiment, the titanium dioxide comprises about 23 v/v % of the composition. In an embodiment, the composition further comprises at least one pigment. In an embodiment, the at least one pigment comprises CuCr₂O₄. In an embodiment, the at least one pigment is CuCr₂O₄.

In still another aspect, the present disclosure provides a method of coating a substrate in a cured finish, the method comprising: (a) combining a first liquid mixture comprising a bisphenol A-epoxide polymer, a siloxane polymer, a hydroxide salt, and a carbonate salt with a second liquid mixture comprising a first cyclic diamine, a second cyclic diamine, a phenol, and an alcohol different from the phenol comprising one or more aromatic groups, thereby producing a combined wet mixture; (b) mixing the combined wet mixture; (c) applying the combined wet mixture to a substrate to be coated; (d) waiting for a duration until the combined wet mixture cures into a dry cured coating.

In an embodiment of the method of coating a substrate in a cured finish, the first liquid mixture further comprises an epoxidized oil. In an embodiment, the first liquid mixture and second liquid mixture are mixed at a relative volumetric ratio ranging from 30:70 to 70:30. In an embodiment, first liquid mixture and second liquid mixture are mixed at a relative volumetric ratio of about 50:50.

In an embodiment, the bisphenol A-epoxide polymer is bisphenol A epichlorohydrin polymer. In an embodiment, the siloxane polymer is a polydimethylsiloxane. In an embodiment, the polydimethylsiloxane is polyalkyleneoxide modified polydimethylsiloxane. In an embodiment, the hydroxide salt is aluminum hydroxide. In an embodiment, the carbonate salt is calcium carbonate. In an embodiment, the first cyclic diamine is isophorone diamine. In an embodiment, the second cyclic diamine is 1,3-benzenedimethanamine. In an embodiment, the phenol is nonylphenol. In an embodiment, the alcohol different from the phenol comprising one or more aromatic groups is benzyl alcohol. In an embodiment, the epoxidized oil is epoxidized soybean oil. In an embodiment, the epoxidized soybean oil is 100%-epoxidized soybean oil.

In an embodiment of the method, the first composition comprises: 20 v/v % to 45 v/v % bisphenol A-epoxide polymer, 0.2 v/v % to 0.4 v/v % siloxane polymer, 4 v/v % to 8 v/v % hydroxide salt, and 55 v/v % to 80 v/v % carbonate salt. In an embodiment, the first composition comprises: 25 v/v % to 35 v/v % bisphenol A-epoxide polymer, 0.25 v/v % to 0.35 v/v % siloxane polymer, 5 v/v % to 7 v/v % hydroxide salt, and 60 v/v % to 75 v/v % carbonate salt. In an embodiment, the first composition comprises: 28 v/v % to 32 v/v % bisphenol A-epoxide polymer, 0.25 v/v % to 0.35 v/v % siloxane polymer, 5.5 v/v % to 6.5 v/v % hydroxide salt, and 64 v/v % to 66 v/v % carbonate salt.

In an embodiment, the second liquid mixture comprises: 15 v/v % to 45 v/v % first cyclic diamine, 8 v/v % to 22 v/v % second cyclic diamine, 18 v/v % to 40 v/v % phenol, and 15 v/v % to 30 v/v % alcohol different from the phenol comprising one or more aromatic groups. In an embodiment, the second liquid mixture comprises: 25 v/v % to 35 v/v % first cyclic diamine, 12 v/v % to 18 v/v % second cyclic diamine, 22 v/v % to 32 v/v % phenol, and 20 v/v % to 25 v/v % alcohol different from the phenol comprising one or more aromatic groups. In an embodiment, the second liquid mixture comprises: 32 v/v % to 34 v/v % first cyclic diamine, 16.5 v/v % to 17.5 v/v % second cyclic diamine, 27 v/v % to 29 v/v % phenol, and 21 v/v % to 23 v/v % alcohol different from the phenol comprising one or more aromatic groups.

In an embodiment, the first liquid mixture comprises 3 v/v % to 8 v/v % epoxidized oil. In an embodiment, the first liquid mixture comprises 3.5 v/v % to 7 v/v % epoxidized oil. In an embodiment, the first liquid mixture comprises about 3.5 v/v % epoxidized oil.

In an embodiment, the first liquid mixture further comprises one or more pigments. In an embodiment, the one or more pigments comprise CuCr₂O₄. In an embodiment, the first liquid mixture comprises about 0.002 v/v % CuCr₂O₄.

In an embodiment, the first liquid mixture comprises about 2 v/v % TiO₂.

In an embodiment, the second liquid mixture comprises amine-epoxy resin adduct.

In an embodiment of the method, the substrate to be coated is selected from the group consisting of: ceramic or fiberglass. In an embodiment, the fiberglass is fiberglass-acrylic or fiberglass-polyester.

In an embodiment of the method, the duration in step (d) is about 36 hours.

In an embodiment, wherein the mixing in step (b) comprises stirring, agitating, shaking, or a combination thereof. In an embodiment, the mixing if step (b) is performed until the combined wet mixture is homogenized.

In an embodiment of the method, applying the combined wet mixture to the substrate to be coated is done using a flocked paint roller.

### BRIEF DESCRIPTION OF DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIGS. 1A-ID are exemplary perspective-view images depicting a method of coating, using a composition of the present disclosure.

FIG. 1A is an overhead perspective photograph of a wash basin which has been stained on its upper surface with permanent marker. The basin is masked along a midline with blue masking tape.

FIG. 1B is a low-angle perspective of the test basin after being coated in a batch of a composition of the present disclosure.

FIG. 1C is a perspective view of the test basin after the strip of masking tape has been removed, indicating the difference in look between coated and uncoated portions.

FIG. 1D is an oblique low-angle perspective view of the test basin after the strip of masking tape has been removed, indicating the difference in look between coated and uncoated portions.

FIG. 2 is an image of ceramic tile coated with Mixture II using a horizontal application.

FIG. 3 is an image of ceramic tile coated with Mixture II using a vertical application.

FIG. 4 is an image of fiberglass material coated with Mixture II using a horizontal application.

FIG. 5 is an image of acrylic material coated with Mixture II using a horizontal application.

FIG. 6 is an image of acrylic material coated with Mixture II using a vertical application.

FIG. 7 is a table showing the adhesion properties of several different coatings.

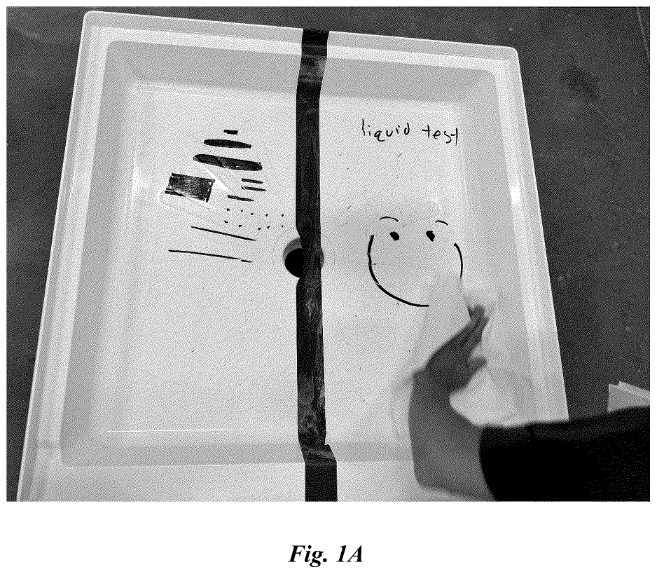

### DETAILED DESCRIPTION

The present disclosure may be further understood by reference to the following detailed description.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

The present disclosure provides systems, compositions, and methods of coating a substrate. More particularly, the present disclosure provides systems, compositions, and methods of coating a fiberglass or ceramic substrate, such as a wash basin or bathtub, with a curable epoxy which provides a durable, aesthetically pleasing coating that resembles porcelain in its appearance.

The curative mixtures and methods described herein provide improved cure time, adhesion to substrate, flexibility, gloss, viscosity, and other mechanical properties when compared to the performance of prior-art compositions developed for this purpose. The systems and compositions described herein demonstrates good workability with little to no foaming during processing and application. In embodiments, the systems and compositions of the present disclosure, upon curing on a substrate, result in a white or off-white coating. The systems and compositions described herein may be non-pigmented, slightly pigmented, or highly pigmented. Thus, in embodiments, the systems and compositions of the present disclosure may be colored in any desired coloration. The systems and compositions described herein may be non-filled, slightly filled, or highly filled.

It will be understood to persons skilled in the art that where a mixture is provided where two or more components consists of a percentage range (whether in in v/v % or wt %) of the mixture, that the combined percentages of the two or more components shall sum to about 100. For illustrative example, where a mixture consists of 30 wt % to 50 wt % of component X and 50 wt % to 70 wt % of component Y, then if an embodiment of such mixture consists of 40 wt % of component X then the embodiment would therefore consist of 60 wt % of component Y. For another illustrative example, where a mixture consists of 10 wt % to 30 wt % of component α, 40 wt % to 60 wt % of component β, and 30 wt % to 50 wt % of component γ, then embodiments of the mixture shall consist of a wt % for each of the respective components α, β, and γ that adds up to 100. In contrast, the terms “comprises”, “comprising”, “includes”, “including”, “has”, “having”, and their conjugates have the meaning indicated above, such that the sum may be, but is not necessarily, less than 100%.

Surfaces used in floors, walls, sink basins, showers, bathtubs, washroom fixtures, and other household fixtures tend to become worn in discolored over time. There is a need for a convenient, easy-to-use coating products and methods for renewing the look and to protect the original surface of substrates such as ceramic tile, porcelain, fiberglass.

In an aspect, the present disclosure provides a curable coating system, the system comprising: a first composition and a second composition, which may be mixed together shortly before application. Mixing the first component with the second component initiates a chemical reaction which causes the mixture to cure. The first composition of the curable coating system comprises: a bisphenol A-epoxide polymer, a siloxane polymer, a hydroxide salt, and a carbonate salt; and the second composition of the curable coating system comprises: a first cyclic diamine, a second cyclic diamine, a phenol, and an alcohol different from the phenol comprising one or more aromatic groups, wherein mixing the first composition with the second composition causes the combined mixture to cure.

In an embodiment of the curable coating system of the present disclosure, the first composition further comprises an epoxidized oil.

In an embodiment, mixing the first composition with the second composition at a relative volumetric ratio ranging from 30:70 to 70:30 causes the combined mixture to cure. In an embodiment, mixing the first composition with the second composition at a relative volumetric ratio ranging from 35:65 to 65:35 causes the combined mixture to cure. In an embodiment, mixing the first composition with the second composition at a relative volumetric ratio ranging from 40:60 to 60:40 causes the combined mixture to cure. In an embodiment, mixing the first composition with the second composition at a relative volumetric ratio ranging from 45:55 to 55:45 causes the combined mixture to cure. In an embodiment, mixing the first composition with the second composition at a relative volumetric ratio ranging from 47:54 to 53:47 causes the combined mixture to cure. In an embodiment, mixing the first composition with the second composition at a relative volumetric ratio ranging from 48:52 to 52:48 causes the combined mixture to cure. In an embodiment, mixing the first composition with the second composition at a relative volumetric ratio ranging from 49:51 to 51:49 causes the combined mixture to cure. In any embodiment, mixing the first composition with the second composition at a relative volumetric ratio of about 50:50 causes the combined mixture to cure. In any embodiment, mixing the first composition with the second composition at a relative volumetric ratio of 50:50 causes the combined mixture to cure.

In an embodiment of the curable coating system, the bisphenol A-epoxide polymer is bisphenol A epichlorohydrin polymer. In an embodiment, the siloxane polymer is a polydimethylsiloxane. In an embodiment, the polydimethylsiloxane is polyalkyleneoxide modified polydimethylsiloxane. In an embodiment, the hydroxide salt is aluminum hydroxide. In an embodiment, the carbonate salt is calcium carbonate. In an embodiment, the first cyclic diamine is isophorone diamine. In an embodiment, the second cyclic diamine is 1,3-benzenedimethanamine. In an embodiment, the phenol is nonylphenol. In an embodiment, the alcohol different from the phenol comprising one or more aromatic groups is benzyl alcohol.

Either composition of the system may contain small amounts of silica. For example, the first composition may contain less than 1 wt % silica. The first composition may contain about 0.7 wt % silica.

In an embodiment, the epoxidized oil is an epoxidized vegetable oil or seed oil. In an embodiment, epoxidized soybean oil. In an embodiment, the epoxidized soybean oil is an at least 80%-epoxidized soybean oil. In an embodiment, the epoxidized soybean oil is 100%-epoxidized soybean oil.

In any embodiment, the first composition may comprise: 20 v/v % to 45 v/v % bisphenol A-epoxide polymer, 0.2 v/v % to 0.4 v/v % siloxane polymer, 4 v/v % to 8 v/v % hydroxide salt, and 55 v/v % to 80 v/v % carbonate salt. In an embodiment, the first composition comprises: 25 v/v % to 35 v/v % bisphenol A-epoxide polymer, 0.25 v/v % to 0.35 v/v % siloxane polymer, 5 v/v % to 7 v/v % hydroxide salt, and 64 v/v % to 76 v/v % carbonate salt. In an embodiment, the first composition comprises: about 29 v/v % bisphenol A-epoxide polymer, about 0.20 v/v % to 0.40 v/v % siloxane polymer, about 6 v/v % hydroxide salt, and about 65 v/v % carbonate salt. In an embodiment, the first composition comprises: 29 v/v % bisphenol A-epoxide polymer, 0.20 v/v % to 0.40 v/v % siloxane polymer, 6 v/v % hydroxide salt, and 65 v/v % carbonate salt.

In an embodiment, the second component may comprise: 15 v/v % to 45 v/v % first cyclic diamine, 8 v/v % to 22 v/v % second cyclic diamine, 18 v/v % to 40 v/v % phenol, and 15 v/v % to 30 v/v % alcohol different from the phenol comprising one or more aromatic groups. In an embodiment, the second component comprises: 25 v/v % to 35 v/v % first cyclic diamine, 12 v/v % to 18 v/v % second cyclic diamine, 22 v/v % to 32 v/v % phenol, and 20 v/v % to 25 v/v % alcohol different from the phenol comprising one or more aromatic groups. In an embodiment, the second component comprises: about 33 v/v % first cyclic diamine, about 17 v/v % second cyclic diamine, about 28 v/v % phenol, and about 22 v/v % alcohol different from the phenol comprising one or more aromatic groups.

In an embodiment, the first component comprises 3 v/v % to 8 v/v % epoxidized oil. In an embodiment, the first component comprises 4 v/v % to 7 v/v % epoxidized oil. In an embodiment, the first component comprises about 6 v/v % epoxidized oil. In an embodiment, the first component comprises 6 v/v % epoxidized oil.

In an embodiment, the first component further comprises one or more pigments. The one or more pigments may comprise any suitable organic or inorganic pigment.

In an embodiment, the first component comprises about 2 v/v % TiO₂. In an embodiment, the first component comprises 2 v/v % TiO₂. In an embodiment, the first component may comprise silica. In an embodiment, the first component may comprise less than 1 wt % silica. In an embodiment, the first component may comprise about 0.7 wt % silica.

In an embodiment, the first component comprises about 0.002 v/v % CuCr₂O₄. In an embodiment, the first component comprises 0.002 v/v % CuCr₂O₄.

In an embodiment, the second component comprises amine-epoxy resin adduct.

In another aspect, the present disclosure provides a coating composition comprising a liquid mixture comprising a bisphenol A-epoxide polymer, a siloxane polymer, a hydroxide salt, a carbonate salt, at least one cyclic diamine, a phenol, and an alcohol different from the phenol comprising one or more aromatic groups. In any embodiment of the coating composition, the composition may further comprise an epoxidized oil.

In an embodiment, the liquid mixture comprises: 10 v/v % to 30 v/v % bisphenol A-epoxide polymer, 0.10 v/v % to 1 v/v % siloxane polymer, 1 v/v % to 8 v/v % hydroxide salt, 20 v/v % to 50 v/v % carbonate salt, 10 v/v % to 30 v/v % at least one cyclic diamine, 4 v/v % to 14 v/v % phenol, and 4 v/v % to 14 v/v % alcohol different from the phenol comprising one or more aromatic groups. In an embodiment, the liquid mixture comprises: 16 v/v % to 24 v/v % bisphenol A-epoxide polymer, 0.20 v/v % to 0.40 v/v % siloxane polymer, 3 v/v % to 5 v/v % hydroxide salt, 35 v/v % to 45 v/v % carbonate salt, 14 v/v % to 18 v/v % at least one cyclic diamine, 6 v/v % to 12 v/v % phenol, and 5 v/v % to 11 v/v % alcohol different from the phenol comprising one or more aromatic groups. In an embodiment, the liquid mixture comprises: 20 v/v % to 21 v/v % bisphenol A-epoxide polymer, 0.26 v/v % to 0.34 v/v % siloxane polymer, 4.2 v/v % to 4.8 v/v % hydroxide salt, 39 v/v % to 41 v/v % carbonate salt, 16.5 v/v % to 17.5 v/v % at least one cyclic diamine, 9 v/v % to 10 v/v % phenol, and 7 v/v % to 8 v/v % alcohol different from the phenol comprising one or more aromatic groups.

In an embodiment, the liquid mixture further comprises about 1 v/v % to 5 v/v % epoxidized oil. In an embodiment, the liquid mixture further comprises about 2 v/v % to 4 v/v % epoxidized oil. In an embodiment, the liquid mixture further comprises about 3 v/v % epoxidized oil.

In an embodiment, the at least one cyclic diamine comprises two different species of cyclic diamine. In an embodiment, the bisphenol A-epoxide polymer is bisphenol A epichlorohydrin polymer. In an embodiment, the siloxane polymer is a polydimethylsiloxane. In an embodiment, the polydimethylsiloxane is polyalkyleneoxide modified polydimethylsiloxane. In an embodiment, the hydroxide salt is aluminum hydroxide. In an embodiment, the carbonate salt is calcium carbonate. In an embodiment, the at least one cyclic diamine comprises isophorone diamine. In an embodiment, the at least one cyclic diamine comprises 1,3-benzenedimethanamine. In an embodiment, the phenol is nonylphenol.

In an embodiment, the epoxidized oil is epoxidized vegetable or seed oil. In an embodiment, the epoxidized oil is epoxidized soybean oil. In an embodiment, the epoxidized soybean oil is at least 80%-epoxidized soybean oil. In an embodiment, the epoxidized soybean oil is 100%-epoxidized soybean oil. In an embodiment, the alcohol different from the phenol comprising one or more aromatic groups is benzyl alcohol. In an embodiment, the composition further comprises amine-epoxy resin adduct. In an embodiment, the composition further comprises titanium dioxide.

In an embodiment, the titanium dioxide comprises between 18 v/v % and 26 v/v % of the composition. In an embodiment, the titanium dioxide comprises between 20 v/v % and 24 v/v % of the composition. In an embodiment, the titanium dioxide comprises about 23 v/v % of the composition. In an embodiment, the composition further comprises at least one pigment. The at least one pigment may comprise any suitable organic or inorganic pigment. In an embodiment, the at least one pigment comprises CuCr₂O₄. In an embodiment, the at least one pigment is CuCr₂O₄.

In any embodiment, the coating composition may comprise small amounts of silica. For example, the composition may comprise less than 1 wt % silica. The composition may comprise less than 0.5 wt % silica. The composition may comprise about 0.4 wt %. The composition may comprise about 0.35 wt %.

In still another aspect, the present disclosure provides a method of coating a substrate in a cured finish, the method comprising: (a) combining a first liquid mixture comprising a bisphenol A-epoxide polymer, a siloxane polymer, a hydroxide salt, and a carbonate salt with a second liquid mixture comprising a first cyclic diamine, a second cyclic diamine, a phenol, and an alcohol different from the phenol comprising one or more aromatic groups, thereby producing a combined wet mixture; (b) mixing the combined wet mixture; (c) applying the combined wet mixture to a substrate to be coated; (d) waiting for a duration until the combined wet mixture cures into a dry cured coating. In step (b), the mixing may comprise stirring, agitating, shaking, or a combination thereof.

The combined wet mixture may be applied at any suitable rate, any suitable thickness, and at any suitable temperature. In embodiments, the thickness may be from 0.5 mm to 50 mm. In embodiments, the thickness may be from 1 mm to 30 mm. In embodiments, the thickness may be from 2 mm to 20 mm. In embodiments, the thickness may be from 3 mm to 15 mm. In embodiments, the thickness may be from 3.5 mm to 12 mm. In embodiments, the thickness may be from 4 mm to 10 mm.

In an embodiment of the method of coating a substrate in a cured finish, the first liquid mixture further comprises an epoxidized oil. In an embodiment, the first liquid mixture and second liquid mixture are mixed at a relative volumetric ratio ranging from 30:70 to 70:30. In an embodiment, the first liquid mixture and second liquid mixture are mixed at a relative volumetric ratio ranging from 35:65 to 65:35. In an embodiment, the first liquid mixture and second liquid mixture are mixed at a relative volumetric ratio ranging from 40:60 to 60:40. In an embodiment, the first liquid mixture and second liquid mixture are mixed at a relative volumetric ratio ranging from 45:55 to 55:45. In an embodiment, the first liquid mixture and second liquid mixture are mixed at a relative volumetric ratio ranging from 53:47 to 47:53. In an embodiment, the first liquid mixture and second liquid mixture are mixed at a relative volumetric ratio ranging from 52:48 to 48:52. In an embodiment, the first liquid mixture and second liquid mixture are mixed at a relative volumetric ratio ranging from 51:49 to 49:51. In an embodiment, first liquid mixture and second liquid mixture are mixed at a relative volumetric ratio of about 50:50. In an embodiment, first liquid mixture and second liquid mixture are mixed at a relative volumetric ratio of 50:50.

In an embodiment, the bisphenol A-epoxide polymer is bisphenol A epichlorohydrin polymer. In an embodiment, the siloxane polymer is a polydimethylsiloxane. In an embodiment, the polydimethylsiloxane is polyalkyleneoxide modified polydimethylsiloxane. In an embodiment, the hydroxide salt is aluminum hydroxide. In an embodiment, the carbonate salt is calcium carbonate. In an embodiment, the first cyclic diamine is isophorone diamine. In an embodiment, the second cyclic diamine is 1,3-benzenedimethanamine. In an embodiment, the phenol is nonylphenol. In an embodiment, the alcohol different from the phenol comprising one or more aromatic groups is benzyl alcohol. In an embodiment, the epoxidized oil is epoxidized vegetable or seed oil. In an embodiment, the epoxidized oil is epoxidized soybean oil. In an embodiment, the epoxidized soybean oil is at least 80%-epoxidized soybean oil. In an embodiment, the epoxidized soybean oil is 100%-epoxidized soybean oil.

In an embodiment of the method, the first composition comprises: 20 v/v % to 45 v/v % bisphenol A-epoxide polymer, 0.2 v/v % to 0.4 v/v % siloxane polymer, 4 v/v % to 8 v/v % hydroxide salt, and 55 v/v % to 80 v/v % carbonate salt. In an embodiment, the first composition comprises: 25 v/v % to 35 v/v % bisphenol A-epoxide polymer, 0.25 v/v % to 0.35 v/v % siloxane polymer, 5 v/v % to 7 v/v % hydroxide salt, and 60 v/v % to 75 v/v % carbonate salt. In an embodiment, the first composition comprises: 28 v/v % to 32 v/v % bisphenol A-epoxide polymer, 0.25 v/v % to 0.35 v/v % siloxane polymer, 5.5 v/v % to 6.5 v/v % hydroxide salt, and 64 v/v % to 66 v/v % carbonate salt.

In an embodiment, the second liquid mixture comprises: 15 v/v % to 45 v/v % first cyclic diamine, 8 v/v % to 22 v/v % second cyclic diamine, 18 v/v % to 40 v/v % phenol, and 15 v/v % to 30 v/v % alcohol different from the phenol comprising one or more aromatic groups. In an embodiment, the second liquid mixture comprises: 25 v/v % to 35 v/v % first cyclic diamine, 12 v/v % to 18 v/v % second cyclic diamine, 22 v/v % to 32 v/v % phenol, and 20 v/v % to 25 v/v % alcohol different from the phenol comprising one or more aromatic groups. In an embodiment, the second liquid mixture comprises: 32 v/v % to 34 v/v % first cyclic diamine, 16.5 v/v % to 17.5 v/v % second cyclic diamine, 27 v/v % to 29 v/v % phenol, and 21 v/v % to 23 v/v % alcohol different from the phenol comprising one or more aromatic groups.

In an embodiment, the first liquid mixture comprises 3 v/v % to 8 v/v % epoxidized oil. In an embodiment, the first liquid mixture comprises 3.5 v/v % to 7 v/v % epoxidized oil. In an embodiment, the first liquid mixture comprises about 3.5 v/v % epoxidized oil.

In an embodiment, the first liquid mixture further comprises one or more pigments. The one or more pigments may comprise any suitable organic or inorganic pigment. In an embodiment, the one or more pigments comprise CuCr₂O₄. In an embodiment, the first liquid mixture comprises about 0.002 v/v % CuCr₂O₄.

In an embodiment, the first liquid mixture comprises about 2 v/v % TiO₂.

In an embodiment, the first liquid mixture comprises silica. In an embodiment, the first liquid mixture comprises less than 1 wt % silica. In an embodiment, the first liquid mixture comprises about 0.7 wt % silica.

In an embodiment, the second liquid mixture comprises amine-epoxy resin adduct.

In some embodiments, the first liquid mixture comprises a bisphenol A-epoxide polymer, a siloxane polymer, a carbonate salt, a pigment suspending agent, and optionally a hydroxide salt; and the second composition comprises: a first cyclic diamine, a second cyclic diamine, a phenol, an alcohol different from the phenol comprising one or more aromatic groups, a carbonate salt, and a pigment suspending agent, wherein mixing the first composition with the second composition causes the combined mixture to cure, and wherein the presence of the carbonate salt in the first liquid mixture and the second liquid mixture reduces the viscosity of the combined mixture by about half. (See the Examples for further discussion on viscosity) The pigment suspending agent may comprise an organic derivative of a bentonite clay and is provided in an amount of about 1 v/v % to about 8 v/v/% of the total combined mixture. In some embodiments the pigment suspending agent is the commercial product BENTONE SD-2. In some embodiments, where the hydroxide salt is not present, it is replaced with the carbonate salt.

In some embodiments, the carbonate salt comprises or consists essentially of calcium carbonate. The total amount of calcium carbonate in the combined mixture may be about 20 v/v % to about 60 v/v/%, or about 20 v/v %, about 25 v/v/%, about 30 v/v/%, about 35 v/v/%, about 40 v/v/%, about 45 v/v/%, about 50 v/v/%, about 55 v/v %, or about 60 v/v/%, of the total volume of the combined mixture, and wherein the first liquid mixture comprises about 30 v/v % to about 40 v/v %, or about 35 v/v % of total amount of calcium carbonate and the second liquid mixture comprises about 60 v/v % to about 70 v/v %, or about 65 v/v % of the total amount of calcium carbonate.

In some embodiments, the total amount of pigment suspending agent present in the combined mixture is about 1 v/v % to about 10 v/v % of the total volume, wherein the first liquid mixture comprises about 10 v/v % to about 90 v/v % of the total pigment suspending agent, and the second liquid mixture comprises about 10 v/v % to about 90 v/v % of the total pigment suspending agent present in the combined mixture.

In an embodiment of the method, the substrate to be coated is selected from the group consisting of: ceramic or fiberglass. In an embodiment, the fiberglass is fiberglass-acrylic or fiberglass-polyester.

In an embodiment of the method, the duration in step (d) is up to five days. In an embodiment of the method, the duration in step (d) is about 36 hours.

The wet mixture may be applied to the substrate using any suitable apparatus including paint roller, paint brush, sponge, paint sprayer, or other suitable means. In an embodiment of the method, applying the combined wet mixture to the substrate to be coated is done using a flocked paint roller.

In an embodiment, steps (c) and (d) are repeated until the desired cured coat thickness is achieved. In an embodiment, steps (c) and (d) are repeated twice, three times, four times, five times, or more.

### EXEMPLARY CLAUSES

Aspects of the present disclosure may be further understood with reference to the following exemplary clauses:

Clause 1. A curable coating system, the system comprising: a first composition and a second composition,
the first composition comprising: a bisphenol A-epoxide polymer, a siloxane polymer, a hydroxide salt, and a carbonate salt; and
the second composition comprising: a first cyclic diamine, a second cyclic diamine, a phenol, and an alcohol different from the phenol comprising one or more aromatic groups,
wherein mixing the first composition with the second composition causes the combined mixture to cure.

Clause 2. The curable coating system of clause 1, wherein the first composition further comprises an epoxidized oil.

Clause 3. The curable coating system of any of clauses 1-2, wherein mixing the first composition with the second composition at a relative volumetric ratio ranging from 30:70 to 70:30 causes the combined mixture to cure.

Clause 4. The curable coating system of any of clauses 1-3, wherein mixing the first composition with the second composition at a relative volumetric ratio of about 50:50 causes the combined mixture to cure.

Clause 5. The curable coating system of any of clauses 1-4, wherein the bisphenol A-epoxide polymer is bisphenol A epichlorohydrin polymer.

Clause 6. The curable coating system of any of clauses 1-5, wherein the siloxane polymer is a polydimethylsiloxane.

Clause 7. The curable coating system of any of clauses 6, wherein the polydimethylsiloxane is polyalkyleneoxide modified polydimethylsiloxane.

Clause 8. The curable coating system of any of clauses 1-7, wherein the hydroxide salt is aluminum hydroxide.

Clause 9. The curable coating system of any of clauses 1-8, wherein the carbonate salt is calcium carbonate.

Clause 10. The curable coating system of any of clauses 1-9, wherein the first cyclic diamine is isophorone diamine.

Clause 11. The curable coating system of any of clauses 1-10, wherein the second cyclic diamine is 1,3-benzenedimethanamine.

Clause 12. The curable coating system of any of clauses 1-11, wherein the phenol is nonylphenol.

Clause 13. The curable coating system of any of clauses 1-12, wherein the alcohol different from the phenol comprising one or more aromatic groups is benzyl alcohol.

Clause 14. The curable coating system of any of clauses 2-13, wherein the epoxidized oil is epoxidized soybean oil.

Clause 15. The curable coating system of any of clauses 14, wherein the epoxidized soybean oil is 100%-epoxidized soybean oil.

Clause 16. The curable coating system of any of clauses 1-15, wherein the first composition comprises:
20 v/v % to 45 v/v % bisphenol A-epoxide polymer,
0.2 v/v % to 0.4 v/v % siloxane polymer,
4 v/v % to 8 v/v % hydroxide salt, and
55 v/v % to 80 v/v % carbonate salt.

Clause 17. The curable coating system of any of clauses 1-16, wherein the first composition comprises:
25 v/v % to 35 v/v % bisphenol A-epoxide polymer,
0.25 v/v % to 0.35 v/v % siloxane polymer,
5 v/v % to 7 v/v % hydroxide salt, and
64 v/v % to 76 v/v % carbonate salt.

Clause 18. The curable coating system of any of clauses 1-17, wherein the first composition
about 29 v/v % bisphenol A-epoxide polymer,
about 0.20 v/v % to 0.40 v/v % siloxane polymer,
about 6 v/v % hydroxide salt, and
about 65 v/v % carbonate salt.

Clause 19. The curable coating system of any of clauses 1-18, wherein the second component comprises:
15 v/v % to 45 v/v % first cyclic diamine,
8 v/v % to 22 v/v % second cyclic diamine,
18 v/v % to 40 v/v % phenol, and
15 v/v % to 30 v/v % alcohol different from the phenol comprising one or more aromatic groups.

Clause 20. The curable coating system of any of clauses 1-19, wherein the second component comprises:
25 v/v % to 35 v/v % first cyclic diamine,
12 v/v % to 18 v/v % second cyclic diamine,
22 v/v % to 32 v/v % phenol, and
20 v/v % to 25 v/v % alcohol different from the phenol comprising one or more aromatic groups.

Clause 21. The curable coating system of any of clauses 1-20, wherein the second component comprises:
about 33 v/v % first cyclic diamine,
about 17 v/v % second cyclic diamine,
about 28 v/v % phenol, and
about 22 v/v % alcohol different from the phenol comprising one or more aromatic groups.

Clause 22. The curable coating system of any of clauses 1-21, wherein the first component comprises 3 v/v % to 8 v/v % epoxidized oil.

Clause 23. The curable coating system of any of clauses 1-22, wherein the first component comprises 4 v/v % to 7 v/v % epoxidized oil.

Clause 24. The curable coating system of any of clauses 1-23, wherein the first component comprises about 6 v/v % epoxidized oil.

Clause 25. The curable coating system of any of clauses 1-24, wherein the first component further comprises one or more pigments.

Clause 26. The curable coating system of any of clauses 1-25, wherein the first component comprises about 2 v/v % TiO₂.

Clause 27. The curable coating system of any of clauses 1-26, wherein the first component comprises about 0.002 v/v % CuCr₂O₄.

Clause 28. The curable coating system of any of clauses 1-27, wherein the second component comprises amine-epoxy resin adduct.

Clause 29. A coating composition comprising a liquid mixture comprising a bisphenol A-epoxide polymer, a siloxane polymer, a hydroxide salt, a carbonate salt, at least one cyclic diamine, a phenol, and an alcohol different from the phenol comprising one or more aromatic groups.

Clause 30. The coating composition of clause 29, further comprising an epoxidized oil.

Clause 31. The coating composition of either of clauses 29-30, wherein the liquid mixture comprises:
10 v/v % to 30 v/v % bisphenol A-epoxide polymer,
0.10 v/v % to 1 v/v % siloxane polymer,
1 v/v % to 8 v/v % hydroxide salt,
20 v/v % to 50 v/v % carbonate salt,
10 v/v % to 30 v/v % at least one cyclic diamine,
4 v/v % to 14 v/v % phenol, and
4 v/v % to 14 v/v % alcohol different from the phenol comprising one or more aromatic groups.

Clause 32. The coating composition of any of clauses 29-31, wherein the liquid mixture comprises:
16 v/v % to 24 v/v % bisphenol A-epoxide polymer,
0.20 v/v % to 0.40 v/v % siloxane polymer,
3 v/v % to 5 v/v % hydroxide salt,
35 v/v % to 45 v/v % carbonate salt,
14 v/v % to 18 v/v % at least one cyclic diamine,
6 v/v % to 12 v/v % phenol, and
5 v/v % to 11 v/v % alcohol different from the phenol comprising one or more aromatic groups.

Clause 33. The coating composition of any of clauses 29-32, wherein the liquid mixture comprises:
20 v/v % to 21 v/v % bisphenol A-epoxide polymer,
0.26 v/v % to 0.34 v/v % siloxane polymer,
4.2 v/v % to 4.8 v/v % hydroxide salt,
39 v/v % to 41 v/v % carbonate salt,
16.5 v/v % to 17.5 v/v % at least one cyclic diamine,
9 v/v % to 10 v/v % phenol, and
7 v/v % to 8 v/v % alcohol different from the phenol comprising one or more aromatic groups.

Clause 34. The coating composition of any of clauses 29-33, wherein the liquid mixture further comprises about 1 v/v % to 5 v/v % epoxidized oil.

Clause 35. The coating composition of any of clauses 29-34, wherein the liquid mixture further comprises about 2 v/v % to 4 v/v % epoxidized oil.

Clause 36. The coating composition of any of clauses 29-35, wherein the liquid mixture further comprises about 3 v/v % epoxidized oil.

Clause 37. The coating composition of any of clauses 29-36, wherein the at least one cyclic diamine comprises two different species of cyclic diamine.

Clause 38. The coating composition of any of clauses 29-37, wherein the bisphenol A-epoxide polymer is bisphenol A epichlorohydrin polymer.

Clause 39. The composition of any of clauses 29-38, wherein the siloxane polymer is a polydimethylsiloxane.

Clause 40. The coating composition of clause 39, wherein the polydimethylsiloxane is polyalkyleneoxide modified polydimethylsiloxane.

Clause 41. The coating composition of any of clauses 29-40, wherein the hydroxide salt is aluminum hydroxide.

Clause 42. The coating composition of any of clauses 29-41, wherein the carbonate salt is calcium carbonate.

Clause 43. The coating composition of any of clauses 29-42, wherein the at least one cyclic diamine comprises isophorone diamine.

Clause 44. The coating composition of any of clauses 29-43, wherein the at least one cyclic diamine comprises 1,3-benzenedimethanamine.

Clause 45. The coating composition of any of clauses 29-44, wherein the phenol is nonylphenol.

Clause 46. The coating composition of any of clauses 30-45, wherein the epoxidized oil is epoxidized soybean oil.

Clause 47. The coating composition of clause 46, wherein the epoxidized soybean oil is 100%-epoxidized soybean oil.

Clause 48. The coating composition of any of clauses 29-47, wherein the alcohol different from the phenol comprising one or more aromatic groups is benzyl alcohol.

Clause 49. The coating composition of any of clauses 29-48, further comprising amine-epoxy resin adduct.

Clause 50. The coating composition of any of clauses 29-49, further comprising titanium dioxide.

Clause 51. The coating composition of clause 50, wherein the titanium dioxide comprises between 18 v/v % and 26 v/v % of the composition.

Clause 52. The coating composition of clause 50, wherein the titanium dioxide comprises between 20 v/v % and 24 v/v % of the composition.

Clause 53. The coating composition of clause 50, wherein the titanium dioxide comprises about 23 v/v % of the composition.

Clause 54. The coating composition of any of clauses 29-53, further comprising at least one pigment.

Clause 55. The coating composition of clause 54, wherein the at least one pigment is CuCr₂O₄.

Clause 56. A method of coating a substrate in a cured finish, the method comprising:
(a) combining a first liquid mixture comprising a bisphenol A-epoxide polymer, a siloxane polymer, a hydroxide salt, and a carbonate salt with a second liquid mixture comprising a first cyclic diamine, a second cyclic diamine, a phenol, and an alcohol different from the phenol comprising one or more aromatic groups, thereby producing a combined wet mixture;
(b) stirring the combined wet mixture;
(c) applying the combined wet mixture to a substrate to be coated;
(d) waiting for a duration until the combined wet mixture cures into a dry cured coating.

Clause 57. The method of clause 56, wherein the first liquid mixture further comprises an epoxidized oil.

Clause 58. The method of any of clauses 56-57, wherein the first liquid mixture and second liquid mixture are mixed at a relative volumetric ratio ranging from 30:70 to 70:30.

Clause 59. The method of any of clauses 56-58, wherein the first liquid mixture and second liquid mixture are mixed at a relative volumetric ratio of about 50:50.

Clause 60. The method of any of clauses 56-58, wherein the bisphenol A-epoxide polymer is bisphenol A epichlorohydrin polymer.

Clause 61. The method of any of clauses 56-59, wherein the siloxane polymer is a polydimethylsiloxane.

Clause 62. The method of any of clauses 61, wherein the polydimethylsiloxane is polyalkyleneoxide modified polydimethylsiloxane.

Clause 63. The method of any of clauses 56-62, wherein the hydroxide salt is aluminum hydroxide.

Clause 64. The method of any of clauses 56-63, wherein the carbonate salt is calcium carbonate.

Clause 65. The method of any of clauses 56-64, wherein the first cyclic diamine is isophorone diamine.

Clause 66. The method of any of clauses 56-65, wherein the second cyclic diamine is 1,3-benzenedimethanamine.

Clause 67. The method of any of clauses 56-66, wherein the phenol is nonylphenol.

Clause 68. The method of any of clauses 56-67, wherein the alcohol different from the phenol comprising one or more aromatic groups is benzyl alcohol.

Clause 69. The method of any of clauses 57-68, wherein the epoxidized oil is epoxidized soybean oil.

Clause 70. The method of clause 69, wherein the epoxidized soybean oil is 100%-epoxidized soybean oil.

Clause 71. The method of any of clauses 56-70, wherein the first composition comprises:
20 v/v % to 45 v/v % bisphenol A-epoxide polymer,
0.2 v/v % to 0.4 v/v % siloxane polymer,
4 v/v % to 8 v/v % hydroxide salt, and
55 v/v % to 80 v/v % carbonate salt.

Clause 72. The method of any of clauses 56-71, wherein the first composition comprises:
25 v/v % to 35 v/v % bisphenol A-epoxide polymer,
0.25 v/v % to 0.35 v/v % siloxane polymer,
5 v/v % to 7 v/v % hydroxide salt, and
60 v/v % to 75 v/v % carbonate salt.

Clause 73. The method of any of clauses 56-72, wherein the first composition comprises:
28 v/v % to 32 v/v % bisphenol A-epoxide polymer,
0.25 v/v % to 0.35 v/v % siloxane polymer,
5.5 v/v % to 6.5 v/v % hydroxide salt, and
64 v/v % to 66 v/v % carbonate salt.

Clause 74. The method of any of clauses 56-73, wherein the second liquid mixture comprises:
15 v/v % to 45 v/v % first cyclic diamine,
8 v/v % to 22 v/v % second cyclic diamine,
18 v/v % to 40 v/v % phenol, and
15 v/v % to 30 v/v % alcohol different from the phenol comprising one or more aromatic groups.

Clause 75. The method of any of clauses 56-74, wherein the second liquid mixture
25 v/v % to 35 v/v % first cyclic diamine,
12 v/v % to 18 v/v % second cyclic diamine,
22 v/v % to 32 v/v % phenol, and
20 v/v % to 25 v/v % alcohol different from the phenol comprising one or more aromatic groups.

Clause 76. The method of any of clauses 56-75, wherein the second liquid mixture comprises:
32 v/v % to 34 v/v % first cyclic diamine,
16.5 v/v % to 17.5 v/v % second cyclic diamine,
27 v/v % to 29 v/v % phenol, and
21 v/v % to 23 v/v % alcohol different from the phenol comprising one or more aromatic groups.

Clause 77. The method of any of clauses 56-76, wherein the first liquid mixture comprises 3 v/v % to 8 v/v % epoxidized oil.

Clause 78. The curable coating system of any of clauses 56-77, wherein the first liquid mixture comprises 3.5 v/v % to 7 v/v % epoxidized oil.

Clause 79. The curable coating system of any of clauses 56-78, wherein the first liquid mixture comprises about 3.5 v/v % epoxidized oil.

Clause 80. The method of any of clauses 56-79, wherein the first liquid mixture further comprises one or more pigments.

Clause 81. The method of any of clauses 56-80, wherein the first liquid mixture comprises about 2 v/v % TiO₂.

Clause 82. The method of any of clauses 56-81, wherein the first liquid mixture comprises about 0.002 v/v % CuCr₂O₄.

Clause 83. The method of any of clauses 56-82, wherein the second liquid mixture comprises amine-epoxy resin adduct.

Clause 84. The method of any of clauses 56-83, wherein the substrate to be coated is selected from the group consisting of: ceramic or fiberglass.

Clause 85. The method of clause 84, wherein the fiberglass is fiberglass-acrylic or

fiberglass-polyester.

Clause 86. The method of any of clauses 56-85, wherein the duration in step (d) is about 36 hours.

Clause 87. The method of any of clauses 56-86, wherein the mixing in step (b) comprises stirring, agitating, shaking, or a combination thereof.

Clause 88. The method of any of clauses 56-87, where in the mixing if step (b) is performed until the combined wet mixture is homogenized.

Clause 89. The method of any of clauses 56-88, wherein applying the combined wet mixture to the substrate to be coated is done using a flocked paint roller.

### EXAMPLES

The compositions and methods of the present disclosure may be further appreciated by way of reference to the following examples.

### Example 1. Exemplary Mixture

The composition of the present disclosure comprises two parts, Part A and Part B. The two parts are mixed together shortly before applying the coating to the surface to be coated.

The compositions of Part A and Part B, presented in terms of exemplary commercial ingredient components, as used in the present example, designated Mixture I, are shown in Table 1A below:

TABLE 1A
Mixture I - Components of the Composition
Mix (Exemplary Commercial Components)

| Part A of Mixture I | | Part B of Mixture I | |
|---|---|---|---|
| | Amount | | Amount |
| Component | (gal) | Component | (gal) |
| Epon 828/Dow | 35 to 45 | (Y) EPI-CURE | 40 to 60 |
| Der331 ™ | | 3381 ™ | |
| Vikoflex 9300 ™ | 4.5 to 7.5 | Epikure 3370 ™ | 40 to 60 |
| Tego Foamex 810 ™ | 0.4 to 0.7 | | |
| R-960 Titanium ™ | 5 to 8 | | |
| Micral AM-550 ™ | 3 to 6 | | |
| OMYACARB 3-FL ™ | 28 to 44 | | |
| Black 30C965 Dynamix ™ | 0.001 to | | |
| | 0.008 | | |

The compositions of Part A and Part B, presented in terms of chemical components, as used in the present example, designated Mixture I, are shown in Table 1B below:

TABLE 1B
Mixture I - Components of the Composition
Mix (Chemical Components)

| Part A of Mixture I | | Part B of Mixture I | |
|---|---|---|---|
| | Amount | | Amount |
| Component | (gal) | Component | (gal) |
| Bisphenol A-epichlorohydrin | 35 to 45 | Isophorone | 20 to 40 |
| polymer | | diamine | |
| 100%-epoxidized soybean oil | 4.5 to 7.5 | Nonylphenol | 15 to 35 |
| Polyalkyleneoxide modified | 0.4 to 0.7 | Benzyl alcohol | 14 to 34 |
| polydimethylsiloxane defoamer | | | |
| Titanium dioxide | 5 to 8 | 1,3-benzene- | 10 to 20 |
| | | dimethanamine | |
| Aluminum hydroxide | 3 to 6 | Amine-epoxy | 5 to 15 |
| | | resin adduct | |
| Calcium carbonate | 28 to 44 | | |
| Chromium copper black pigment | 0.001 to | | |
| CuCr₂O₄ | 0.008 | | |

The compositions were rated for hazardous materials according to industry standards.

Composition Part A contained 20 to 30 wt % bisphenol A-epichlorohydrin polymer, and 10 to 20 wt % titanium (IV) oxide. Some commercial titanium (IV) oxide products may comprise small amounts of silica; accordingly Part A of the mixture may comprise silica. The composition of Part A may include 0.70 wt % silica. Composition Part B contained 20 to 30 wt % isophorone diamine, 20 to 30 wt % nonylphenol, 10 to 20 wt % benzyl alcohol, and 15 wt % 1,3-benzenedimethanamine.

### Example 2. Performance Tests

In the present example, the composition of the present disclosure was prepared according to Mixture II, below, and applied to various surfaces. Its performance was compared to that of other coating compositions available on the market, using certain industry-standard performance tests.

The batch prepared for the test was Mixture II, the exemplary commercial components of which are shown in Table 2A, below:

TABLE 2A
Mixture II - Components of the Composition
Mix (Exemplary Commercial Components)

| Part A of Mixture II | | Part B of Mixture II | |
|---|---|---|---|
| | Amount | | Amount |
| Component | (gal) | Component | (gal) |
| Epon 828/Dow | 4 to 6 | (Y) EPI-CURE | 3 to 5 |
| Der331 ™ | | 3381 ™ | |
| Tego Foamex 810 ™ | 0.04 to 0.08 | Epikure 3370 ™ | 3 to 5 |
| R-960 Titanium ™ | 2 to 3 | | |
| Micral AM-550 ™ | 0.5 to 1.5 | | |
| OMYACARB 3-FL ™ | 8 to 12 | | |
| Black 30C965 Dynamix ™ | 0.001 to | | |
| | 0.003 | | |

The batch prepared for the test was Mixture II, the commercial components of which are shown in Table 2B, below:

TABLE 2B
Mixture II - Components of the Composition
Mix (Chemical Components)

| Part A of Mixture II | | Part B of Mixture II | |
|---|---|---|---|
| | Amount | | Amount |
| Component | (gal) | Component | (gal) |
| Bisphenol A- | 4 to 6 | Isophorone | 2 to 4 |
| epichlorohydrin polymer | | diamine | |
| polyalkyleneoxide modified | 0.04 to 0.08 | Nonylphenol | 1.5 to 3 |
| polydimethylsiloxane | | | |
| TiO₂ | 2 to 3 | Benzyl alcohol | 1 to 2 |
| aluminum hydroxide | 0.5 to 1.5 | 1,3-benzene- | 1 to 2 |
| | | dimethanamine | |
| calcium carbonate | 8 to 12 | Amine-epoxy | 0.5 to 1 |
| | | resin adduct | |
| Chromium copper black pigment | 0.001 to | | |
| CuCr₂O₄ | 0.003 | | |

The Mixture II of the composition of the present disclosure was tested against: Homax® Tough as Tile, Krylon® Tub and Tile Ultra Repair Finish-2-part Epoxy, Krylon® Tub and Tile Ultra Repair Finish Spray, and Rust-Oleum® Tub and Tile Refinishing Kit.

All commercial products were applied and cured according to the manufacturer's application instructions, including substrate preparation.

Substrates tested included: white ceramic tile, acrylic fiberglass tub, and fiberglass/polyester.

Products were applied according to manufacturer's instructions in both horizontal-to-the-ground and vertical-to-the-ground orientations.

### Results.

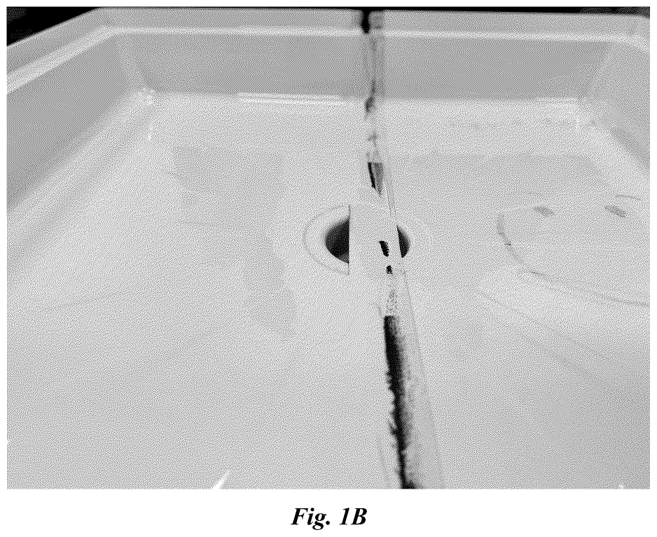

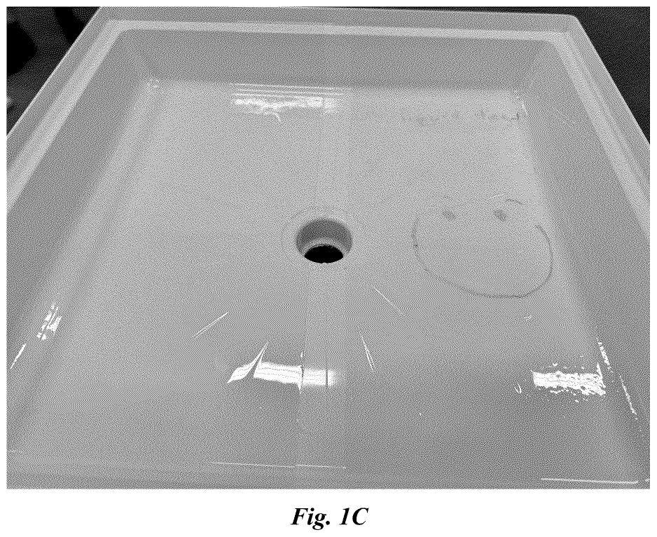

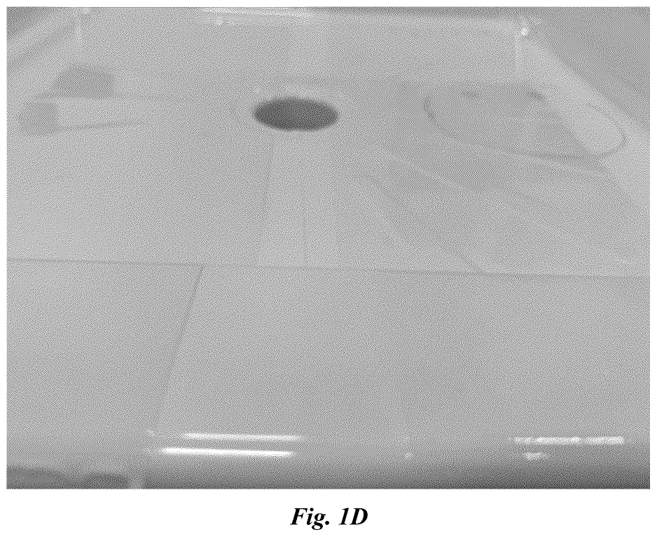

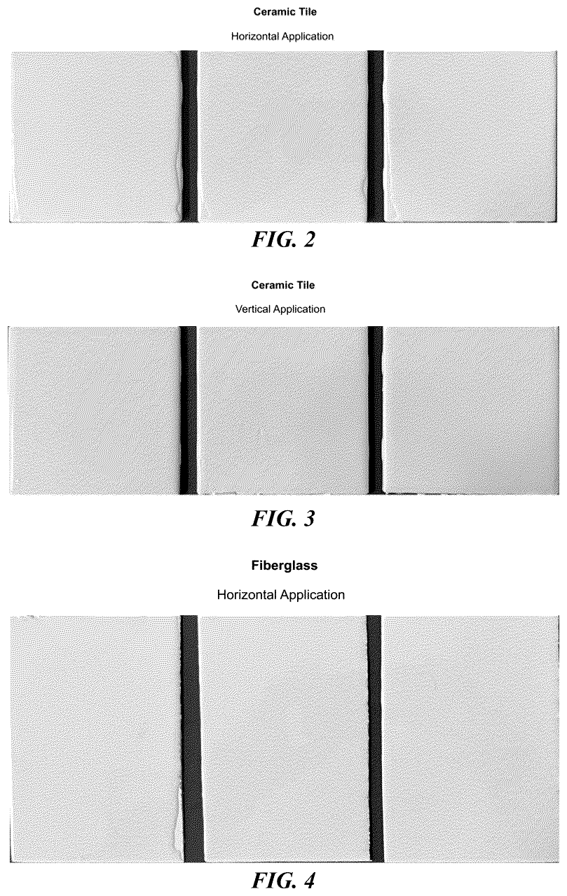

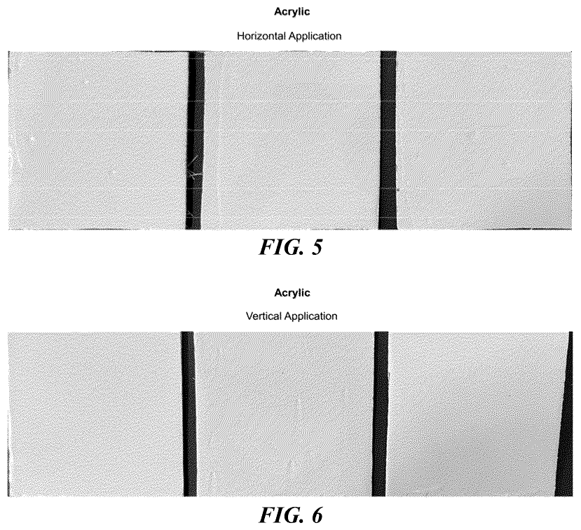

Photographs showing the performance results for Mixture II coated on different materials are shown in FIGS. 2-6.

The parts of the Mixture II of the composition of the present disclosure were combined, stirred together, and was applied to the test surfaces with a flocked roller.

Mixture II was rated and compared with the comparison products on a variety of performance metrics.

TABLE 3A
Performance Score Notes, Mixture II

| Mixture II: | Application Notes: | | |
|---|---|---|---|
| | Sample Painted on with Flocked roller. | | |
| | Odor during application rated 1 of 10 | | |
| | Film Formation (Quality and Leveling) Thick -Good | | |
| | Coverage. 1 coat coverage. | | |
| | Minimal Sag. Back rolling necessary for sag | | |
| | prevention due to size of sample. | | |
| Appearance after | Ceramic Tile | Fiberglass | Acrylic |
| Cure: | smooth | smooth | mostly smooth, |
| Substrates: | smooth, few | smooth, | some dimples |
| Horizontal | dimples | contaminants | smooth, |
| Vertical | | from floor | contaminants |
| | | | from floor |
| Appearance after | Ceramic Tile | Fiberglass | Acrylic |
| 24-hour water | no blisters, no | no blisters, | smooth, no |
| bath @ 150° F.: | discoloration, | smooth | blisters, slight |
| Substrates: | smooth, some of | smooth, no | discoloration |
| Horizontal | the gloss is | blisters, matte | smooth, no |
| Vertical | lost smooth, no | appearance | blisters, matte |
| | blisters, less | | appearance |
| | gloss than | | |
| | original | | |
| | appearance | | |
| | (matte) | | |

TABLE 3B
Performance Score Notes, Krylon ® 2-Part

| Krylon ® 2-Part | Application Notes: | | |
|---|---|---|---|
| Epoxy: | | | |
| Appearance after | Ceramic Tile | Fiberglass | Acrylic |
| Cure: | smooth | smooth | smooth |
| Substrates: | smooth | [symbol] | [symbol] |
| Horizontal | | | |
| Vertical | | | |
| Appearance after | smooth, | smooth, | smooth, |
| 24-hour water | discoloration, some | yellowish, | discoloration, |
| bath @ 150° F.: | of the residue/ | no blisters | matte, no |
| Horizontal | coating comes | smooth, no | blisters |
| Vertical | off the tile | blisters, | smooth, |
| | smooth, no blisters, | discoloration, | no blisters, |
| | discoloration, matte | matte | discoloration, |
| | some of the residue | | matte |
| | comes off the tile | | appearance |

[symbol]

indicates data missing or illegible when filed

TABLE 3C
Performance Score Notes, Rust-Oleum ®

| Rust-Oleum ®: | Application Notes: | | |
|---|---|---|---|
| Appearance | Ceramic Tile | Fiberglass | Acrylic |
| after Cure: | orange peel | orange peel | orange peel |
| Substrates: | orange peel | orange peel | orange peel |
| Horizontal | | | |
| Vertical | | | |
| Appearance after | Slightly | Slight | No blisters, slight |
| 24-hour water | textured | discoloration, | discoloration |
| bath @ 150° F.: | Uniform | no blisters | Discolored, |
| Horizontal | appearance | Slight | still has an |
| | | discoloration, | orange peel |
| | | normal appearance | appearance |

TABLE 3D
Performance Score Notes, Krylon ® Spray

| Krylon ® Spray Can | Application Notes: | | |
|---|---|---|---|
| Appearance after Cure: | Ceramic Tile | Fiberglass | Acrylic |
| Substrates: | slight texture | slight texture | slight texture |
| Horizontal | slight texture, not as | slight texture | slight texture, not as |
| Vertical | smooth as horizontal | and sag | smooth as horizontal |
| Appearance after | Ceramic Tile | Fiberglass | Acrylic |
| 24- hour water | matte appearance, | matte appearance, | matte appearance, no |
| bath @ 150 F.: | coating flakes off, no | discoloration, no | blisters, discoloration, |
| Substrates: | blisters | blisters, smooth | smooth |
| Horizontal | matte appearance, | matte appearance, | matte appearance, no |
| Vertical | coating flakes off, no | discoloration, no | blisters, discoloration, |
| | blisters | blisters, smooth | smooth |

| | |
|---|---|
| Homax ®: | Application Notes: |

| | | | |
|---|---|---|---|
| Appearance after Cure: | Ceramic Tile | Fiberglass | Acrylic |
| Substrates: | slight texture | slight texture | slight texture |
| Horizontal | slight texture | rough texture | rough texture |
| Vertical | | | |
| Appearance after | Ceramic Tile | Fiberglass | Acrylic |
| 24-hour water | yellowish, heavily | yellowish, | yellowish, light- |
| bath @ 150° F.: | textured, coating | textured | colored circles |
| Substrates: | scratches off easily | yellowish, | on surface |
| Horizontal | yellowish, heavily | textured | yellowish, light- |
| Vertical | textured, coating | | colored circles |
| | scratches off easily | | everywhere |

Color Performance was tested according to an average of five readings for each sample on a three-dimensional color point score. L refers to relative black-white level, with 100 being fully white and 0 being fully black. The A dimension refers to relative green-red level, with -A being more green, 0 being neutral, and +A being more red. The B dimension refers to relative blue-yellow level, with -B being more blue, 0 being neutral, and +B being more yellow. Optimal performance would be high L (>90), and each of A and B as near as possible to 0.

The results of the test are shown in Table 4, below.

TABLE 4
COLOR TEST
Acrylic Substrates: coated Horizontally and Vertically

| | | | | | |
|---|---|---|---|---|---|
| L | A | B | L | A | B |

Mixture II

| | | | | | | | |
|---|---|---|---|---|---|---|---|
| Horizontal - 1 | 92.32 | −0.48 | 2.32 | Vertical - 4 | 91.8 | −0.46 | 2.48 |
| Horizontal - 2 | 92.26 | −0.50 | 2.40 | Vertical - 5 | 92.16 | −0.40 | 2.48 |
| Horizontal - 3 | 92.30 | −0.46 | 2.36 | Vertical - 6 | 91.84 | −0.32 | 2.52 |

Krylon ® 2-Part Epoxy

| | | | | | | | |
|---|---|---|---|---|---|---|---|
| Horizontal - 1 | 95.86 | −0.88 | 3.24 | Vertical - 4 | 95.68 | −0.84 | 3.10 |
| Horizontal - 2 | 95.80 | −0.78 | 3.28 | Vertical - 5 | 95.2 | −0.90 | 2.82 |
| Horizontal - 3 | 95.92 | −0.80 | 3.32 | Vertical - 6 | 95.48 | −0.84 | 3.06 |

Rust-Oleum ®

| | | | | | | | |
|---|---|---|---|---|---|---|---|
| Horizontal - 1 | 79.60 | 0.20 | 3.46 | Vertical - 4 | 80.54 | 0.08 | 3.44 |
| Horizontal - 2 | 79.62 | 0.18 | 3.5 | Vertical - 5 | 79.52 | 0.34 | 3.44 |
| Horizontal - 3 | 79.64 | 0.24 | 3.52 | Vertical - 6 | 80 | 0.34 | 3.34 |

Krylon ® Spray Can

| | | | | | | | |
|---|---|---|---|---|---|---|---|
| Horizontal - 1 | 95.48 | −0.36 | 2.54 | Vertical - 4 | 95.58 | −0.38 | 2.30 |
| Horizontal - 2 | 95.60 | −0.32 | 2.52 | Vertical - 5 | 95.48 | −0.38 | 2.46 |
| Horizontal - 3 | 95.76 | −0.24 | 2.64 | Vertical - 6 | 95.54 | −0.64 | 2.28 |

Homax ®

| | | | | | | | |
|---|---|---|---|---|---|---|---|
| Horizontal - 1 | 96.06 | −0.98 | 4.34 | Vertical - 4 | 96.02 | −0.98 | 3.76 |
| Horizontal - 2 | 96.10 | −0.96 | 4.36 | Vertical - 5 | 96.32 | −0.98 | 3.94 |
| Horizontal - 3 | 96.28 | −0.88 | 4.56 | Vertical - 6 | 95.98 | −0.94 | 3.96 |

### Gloss Performance

The gloss performance test evaluates the surface reflection properties of a material by measuring light reflectivity at three standardized angles: 20 degrees, 60 degrees, and 85 degrees. These angles represent different levels of reflectance sensitivity, with 60 degrees serving as the intermediate and most widely used measurement angle in the art for general surface evaluation. Among the three angles, the 60-degree gloss measurement is considered the most significant because it provides a balanced and representative assessment of a material's gloss for most coating applications. This angle is used as a standard for comparing gloss across a wide range of surfaces, making it crucial for consistent and meaningful performance evaluations.

horizontal substrates, Mixture II exhibited the highest gloss value compared to test products.

TABLE 5
Gloss
Acrylic Substrates: coated Horizontally and Vertically

| | Mixture II | | | | | | |
|---|---|---|---|---|---|---|---|
| | 20° | 60° | 85° | | 20° | 60° | 85° |
| Horizontal - 1 | 80.2 | 98 | 90.9 | Vertical - 4 | 52.2 | 88.2 | 94.3 |
| Horizontal - 2 | 83.2 | 97.1 | 96.2 | Vertical - 5 | 33.4 | 69.1 | 86.7 |
| Horizontal - 3 | 87.7 | 99.2 | 97.5 | Vertical - 6 | 40.2 | 78.9 | 93.9 |
| | 20 | 60 | 85 | | 20 | 60 | 85 |

Krylon ® 2-Part Epoxy

| | | | | | | | |
|---|---|---|---|---|---|---|---|
| Horizontal - 1 | 60.8 | 91.7 | 96.9 | Vertical - 4 | 54.5 | 91.6 | 88 |
| Horizontal - 2 | 58 | 91.6 | 91.8 | Vertical - 5 | 54.5 | 93.5 | 93.3 |
| Horizontal - 3 | 54.3 | 89.1 | 94.8 | Vertical - 6 | 61.2 | 92.7 | 97.4 |

Rust-Oleum ®

| | | | | | | | |
|---|---|---|---|---|---|---|---|
| Horizontal - 1 | 55.7 | 83.6 | 92.5 | Vertical - 4 | 28.3 | 70.5 | 74.9 |
| Horizontal - 2 | 44.2 | 80.5 | 84.1 | Vertical - 5 | 35 | 77.7 | 83 |
| Horizontal - 3 | 41.2 | 80.1 | 86.7 | Vertical - 6 | 34.1 | 73.2 | 75.5 |

Krylon ® Spray Can

| | | | | | | | |
|---|---|---|---|---|---|---|---|
| Horizontal - 1 | 56 | 86.9 | 95.2 | Vertical - 4 | 31.2 | 70.8 | 80.8 |
| Horizontal - 2 | 55.1 | 86.8 | 92.8 | Vertical - 5 | 37.3 | 79.7 | 84.9 |
| Horizontal - 3 | 62.1 | 88 | 94.9 | Vertical - 6 | 41.9 | 81.7 | 87.8 |

Homax ®

| | | | | | | | |
|---|---|---|---|---|---|---|---|
| Horizontal - 1 | 71 | 90.9 | 96 | Vertical - 4 | 17.6 | 55.4 | 61.5 |
| Horizontal - 2 | 74.3 | 90.9 | 96.3 | Vertical - 5 | 15.6 | 52 | 58.5 |
| Horizontal - 3 | 60.4 | 86.4 | 90.3 | Vertical - 6 | 17.2 | 54.4 | 60.9 |

### Thickness.

TABLE 6
THICKNESS (millimeters)
CRS Substrates: coated Horizontally and Vertically
Mixture II

| | | | |
|---|---|---|---|
| Horizontal - 1 | 8.0 | Vertical - 4 | 5.2 |
| Horizontal - 2 | 10.0 | Vertical - 5 | 4.7 |
| Horizontal - 3 | 8.6 | Vertical - 6 | 4.6 |

Krylon ® 2-Part Epoxy

| | | | |
|---|---|---|---|
| Horizontal - 1 | 4.3 | Vertical - 4 | 4.0 |
| Horizontal - 2 | 4.0 | Vertical - 5 | 4.2 |
| Horizontal - 3 | 4.1 | Vertical - 6 | 4.4 |

Rust-Oleum ®

| | | | |
|---|---|---|---|
| Horizontal - 1 | 3.0 | Vertical - 4 | 2.8 |
| Horizontal - 2 | 2.7 | Vertical - 5 | 2.4 |
| Horizontal - 3 | 2.1 | Vertical - 6 | 2.5 |

Krylon ® Spray Can

| | | | |
|---|---|---|---|
| Horizontal - 1 | 2.2 | Vertical - 4 | 1.9 |
| Horizontal - 2 | 2.0 | Vertical - 5 | 1.8 |
| Horizontal - 3 | 2.1 | Vertical - 6 | 2.2 |

Homax ®

| | | | |
|---|---|---|---|
| Horizontal - 1 | 2.6 | Vertical - 4 | 3.0 |
| Horizontal - 2 | 2.6 | Vertical - 5 | 3.1 |
| Horizontal - 3 | 3.0 | Vertical - 6 | 4.1 |

On horizontal substrates, Mixture II demonstrated a film thickness that was 2× to 4× that of comparison products. On vertical substrates, Mixture II demonstrated the highest thickness.

### Mandrel Bend Test.

TABLE 7
Mandrel Bend
CRS Substrates: coated Horizontally and Vertically

| Substrates | Results |
|---|---|
| Mixture II 4-Vertical | passed @ ⅛″ |
| Mixture II 3-Horizontal | passed @ ⅛″ |
| Krylon ® 2-Part epoxy 1- Horizontal | passed @ ⅛″ |
| Krylon ® 2-Part epoxy 4-Vertical | passed @ ⅛″ |
| Rust-Oleum ® 1-Horizontal | passed @ ¼″, failed @⅛″ |
| Rust-Oleum ® 4-Vertical | failed @ ⅛″ |
| Krylon ® Spray 1-Horizontal | passed @ ¼″, failed @⅛″ |
| Krylon ® Spray 4-Vertical | passed @ ¼″, failed @⅛″ |
| Homax ® 1-Horizontal | passed @ ⅛″ |
| Homax ® 4-Vertical | passed @ ⅛″ |

The ⅛″ mandrel bend represents the greatest “flexibility” of a coating film. Mixture II demonstrated good flexibility at ⅛″ mandrel bend.

### Steel Pen Hardness Test.

TABLE 8
STEEL PEN HARDNESS
0.75 mm Tip (N)
Ceramic Tile Substrates: coated Horizontally and Vertically

| | Results Before 24 - | | Results After 24 - |
|---|---|---|---|
| | hour | | hour |
| Sample | [symbol] | Sample | [symbol] |
| Mixture II-2 Horizontal | 4 N | Mixture II-1 Horizontal | 7 N |
| Mixture II-6 Vertical | 6 N | Mixture II-4 Vertical | 9 N |
| Krylon ® 2-Part Epoxy-2 | 6 N | Krylon ® 2-Part Epoxy-1 | 5 N |
| Horizontal | | | |
| Krylon ® 2-Part Epoxy-5 | 4 N | Krylon ® 2-Part Epoxy-4 | 4 N |
| Rust-Oleum ®-2 Horizontal | 4 N | Rust-Oleum ®-1 Horizontal | 5 N |
| Rust-Oleum ®-5 Vertical | 5 N | Rust-Oleum ®-4 Vertical | 5 N |
| Krylon ® Spray Can-2 | 3 N | Krylon ® Spray Can-1 | *NA |
| Horizontal | | | |
| Krylon ® Spray Can-5 | 3 N | Krylon ® Spray Can-4 | *NA |
| Homax ®-2 Horizontal | 3 N | Homax ®-1 Horizontal | *NA |
| Homax ®-5 Vertical | 4 N | Homax ®-4 Vertical | *NA |

[symbol]

indicates data missing or illegible when filed

This test measures the amount of Force (in Newtons) required to scratch the surface with a 0.75 mm diameter stainless steel sphere. Higher numbers represent higher scratch resistance. Mixture II exhibited the greatest scratch resistance compared to the other products, especially after the 150° F. water soak.

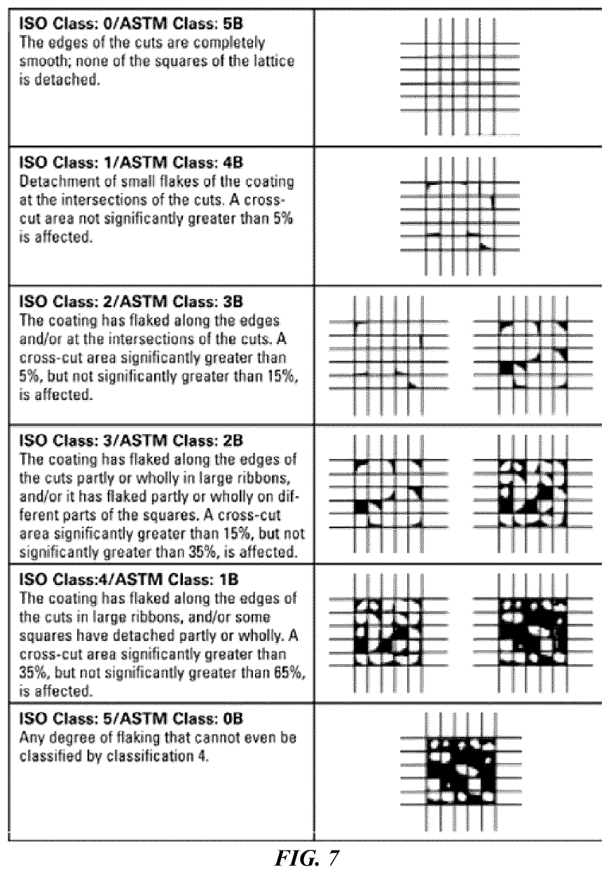

Adhesion results are shown in FIG. 7 and below.

TABLE 9A
Cross Hatch

| | |
|---|---|
| Horizontal | Vertical |

Mixture II

| | | | |
|---|---|---|---|
| CRS | 5 | CRS | 5 |
| Ceramic tile | 5 | Ceramic tile | 5 |
| Fiberglass | 5 | Fiberglass | 5 |
| Acrylic | 3 | Acrylic | 4 |

Krylon ® 2-Part Epoxy

| | | | |
|---|---|---|---|
| CRS | 5 | CRS | 5 |
| Ceramic tile | 5 | Ceramic tile | 5 |
| Fiberglass | 4 | Fiberglass | 4 |
| Acrylic | 5 | Acrylic | 5 |

Rust-Oleum ®

| | | | |
|---|---|---|---|
| CRS | 0 | CRS | 0 |
| Ceramic tile | 5 | Ceramic tile | 5 |
| Fiberglass | 5 | Fiberglass | 5 |
| Acrylic | 5 | Acrylic | 5 |

Krylon ® Spray Can

| | | | |
|---|---|---|---|
| CRS | 2 | CRS | 3 |
| Ceramic tile | 2 | Ceramic tile | 2 |
| Fiberglass | 4 | Fiberglass | 2 |
| Acrylic | 3 | Acrylic | 4 |

Homax ®

| | | | |
|---|---|---|---|
| CRS | 2 | CRS | 2 |
| Ceramic tile | 2 | Ceramic tile | 4 |
| Fiberglass | 4 | Fiberglass | 4 |
| Acrylic | 3 | Acrylic | 3 |

This adhesion test measures the adhesion on a substrate by cutting a cross-hatch pattern into the coating down to the substrate and then using an ASTM-approved tape to remove any coating from the substrate. The scale ranges from 0 to 5, with 5 representing the best adhesion. Mixture II exhibited a “5” on all substrates, except for acrylic tub substrate.

The test was run again after soaking in hot water:

TABLE 9B
Cross Hatch - after samples were submerged in 150° F. water

| | |
|---|---|
| Horizontal | Vertical |

Mixture II

| | | | |
|---|---|---|---|
| Ceramic tile | 5 | Ceramic tile | 5 |
| Fiberglass | 4 | Fiberglass | 4 |
| Acrylic | 5 | Acrylic | 3 |

Krylon ® 2 Part Epoxy

| | | | |
|---|---|---|---|
| Ceramic tile | 5 | Ceramic tile | 5 |
| Fiberglass | 5 | Fiberglass | 5 |
| Acrylic | 5 | Acrylic | 2 |

Rust-Oleum ®

| | | | |
|---|---|---|---|
| Ceramic tile | 3 | Ceramic tile | 3 |
| Fiberglass | 4 | Fiberglass | 4 |
| Acrylic | 4 | Acrylic | 4 |

Krylon ® Spray Can

| | | | |
|---|---|---|---|
| Ceramic tile | 0 | Ceramic tile | 0 |
| Fiberglass | 4 | Fiberglass | 4 |
| Acrylic | 4 | Acrylic | 4 |

Homax ®

| | | | |
|---|---|---|---|
| Ceramic tile | 0 | Ceramic tile | 0 |
| Fiberglass | 4 | Fiberglass | 4 |
| Acrylic | 4 | Acrylic | 4 |

Adhesion was further tested with an X-Cut text. An “X” was slashed into the sample film down to the substrate, and then the film was rated on ease of removal in the area proximate to the cut:
Mixture II: the coating was hard to remove from all substrates except acrylic. On the acrylic, the coating came up as the X was being cut.

Krylon® 2-Part epoxy: The coating required medium force to remove. Came up easiest on acrylic.

Rust-Oleum®: the coating was difficult to remove from all substrates.

KrylonR spray can: the coating was easy to remove from all substrates.

Homax®: the coating was easy to remove from all substrates.

### Example 3. Application of Mixture II

In an example, the follower steps were used to apply Mixture II to a substrate:
1. Substrate may be fiberglass or ceramic;
2. Sand substrate down with 120 grit sandpaper;
3. Clean substrate with isopropyl alcohol and scotch bright pad;
4. Spray water, and wipe off with a shop rag or tack cloth;
5. Tape off the tub for masking;

### Part A and Part B.

6. Pour part B into part A. 100 grams of A to 13 grams of B;
7. Mix with a wooden stir stick (no drill)—you don't want it to get warm or add air. Mix for 5 minutes by hand;
8. Mix until mixture is the texture of oil-based paint;

### Application

9. Pour product out into a plastic paint tray;
10. Flocked foam 4″ mini roller. Sherwin Williams contractor grade;
11. Roll it onto the tub. Furthest point away from you and working towards you;
12. Evenly disperse;
13. Backroll over time on vertical surfaces to work out any running;
14. 90 minutes working time;
14. Film thickness (works itself out by self-leveling); and
15. Set time is 36 hours.

### Example 4. Alternative Application of Coating Composition to Substrate

### (A) Safety Recommendations

The following safety equipment is recommended for all stages of the application process:
Protective Gloves: Wear chemical-resistant gloves to prevent skin contact with the product and solvents.
Safety Glasses or Goggles: Protect your eyes from splashes and airborne particles.
Respirator Mask: Use a respirator with organic vapor cartridges when mixing and applying the product to avoid inhalation of fumes.
Protective Clothing: Wear long sleeves, pants, and closed-toe shoes to protect exposed skin from contact with the product.
Ventilation: Ensure proper ventilation in the work area to minimize the accumulation of fumes or odors.

### (B) Preparing the Area

### Sand and Prepare the Surface:

Use 80-grit sandpaper to sand the surface evenly and thoroughly. Pre-existing conditions will determine the extent of sanding needed:

For very uneven surfaces, more sanding may be required.

For repaired surfaces, ensure all areas are smooth, level, and free of gaps, peels, or rust.

In extreme cases of peeling coatings, a razor blade may be necessary for complete surface preparation.

Use a caulk removal tool or razor blade to cut and remove existing caulk lines.

### Clean the Surface:

Wipe the area using a Scotch-Brite™ pad with 70% isopropyl alcohol. Repeat as needed until all surfaces are clean, dust-free, and unobstructed.

Wipe with Tack Cloth:

Use a tack cloth to remove any remaining dust. Repeat as necessary until the surface is completely clean.

### Tape the Perimeter:

Use 2-inch, medium-adhesion painter's tape to mask off the edges. Ensure the tape is flat, wrinkle-free, and as straight as possible. One line of tape.

### (C) Preparing the Product

Important: Do not proceed until Section A.) Preparing the Area is fully completed.

### Mix Components:

Pour the entire contents of Mixture Part B into the container of Mixture Part A (1,100 grams of A to 200 grams of B).

Mix thoroughly with a stir stick (no power tools). Stir in a looping motion for 30 seconds, then scrape the bottom of the container for an additional 30 seconds, alternating between clockwise and counter-clockwise directions.

Repeat this process for a total of 5 minutes.

### (D) Application

Pour into Paint Tray: Transfer small, workable amounts of the mixed product into a paint tray, adding more as needed.

### Apply to Surface: Use a High-Density, Flocked Foam Mini Roller

Start from the furthest point away from you and work towards yourself, applying the product evenly.

Evenly Disperse: Distribute the product evenly across the surface.
Backroll: On vertical surfaces, backroll periodically to smooth out any runs, and on horizontal surfaces to reducing puddling which may occur if too much product is concentrated to one area.
Working Time: The product has a 60-minute working time.
Film Thickness: The product will self-level to achieve the correct film thickness.
Remove Tape and clean

### Remove Tape:

While the surfaces are still drying, carefully remove all tape used for preparing the surface in Step A.

### Clean the Work Area:

Use hot water and a rag for general cleaning needs, taking care not to touch any freshly coated surfaces. For more extensive cleaning needs, use diluted isopropyl alcohol on a rag.
Clean Up-Tape; Heat gun

### Example 5. Improving Viscosity when Combining the Final Mixture

It was discovered that by moving a percentage of the carbonate salt (e.g., calcium carbonate) and including a pigment suspending agent in both the first liquid mixture and second liquid mixture, the inventors could reduce the viscosity of the combined mixture, which allows a user to hand mix the two components to form the combined mixture. Viscosity measurements where taken using a Brookfield Viscometer at 70° C. of Mixture II with a modified Mixture II. Modified Mixture II was prepared similarly to Mixture II with the only differences being, 1) moving about 65% of calcium carbonate from the first liquid mixture to the second liquid mixture and 2) adding a pigment suspending agent to both the first mixture and second liquid mixture. The results from the viscometer are as follows: the original Mixture II had a viscosity of about 10,160 cps and the modified Mixture II had a viscosity of about 5,700 cps. This shows that the components of the combined mixture may be distributed into the first and second liquid mixtures in a such a way that improves the end users experience with mixing to form the combined mixture, while maintaining the superior results of the cured coating.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

1. A curable coating system, the system comprising: a first composition and a second composition,
the first composition comprising: a bisphenol A-epoxide polymer, a siloxane polymer, a hydroxide salt, and a carbonate salt; and
the second composition comprising: a first cyclic diamine, a second cyclic diamine, a phenol, and an alcohol different from the phenol comprising one or more aromatic groups,
wherein mixing the first composition with the second composition causes the combined mixture to cure.

2. The curable coating system of claim 1, wherein the first composition further comprises an epoxidized oil.

3. The curable coating system of claim 1, wherein mixing the first composition with the second composition at a relative volumetric ratio ranging from 30:70 to 70:30 causes the combined mixture to cure.

4. The curable coating system of claim 1, wherein mixing the first composition with the second composition at a relative volumetric ratio of about 50:50 causes the combined mixture to cure.

5. The curable coating system of claim 1, wherein the bisphenol A-epoxide polymer is bisphenol A epichlorohydrin polymer.

6. The curable coating system of claim 1, wherein the siloxane polymer is a polydimethylsiloxane.

7. The curable coating system of claim 6, wherein the polydimethylsiloxane is polyalkyleneoxide modified polydimethylsiloxane.

8. The curable coating system of claim 1, wherein the hydroxide salt is aluminum hydroxide.

9. The curable coating system of claim 1, wherein the carbonate salt is calcium carbonate.

10. The curable coating system of claim 1, wherein the first cyclic diamine is isophorone diamine.

11. The curable coating system of claim 1, wherein the second cyclic diamine is 1,3-benzenedimethanamine.

12. The curable coating system of claim 1, wherein the phenol is nonylphenol.

13. The curable coating system of claim 1, wherein the alcohol different from the phenol comprising one or more aromatic groups is benzyl alcohol.

14. The curable coating system of claim 2, wherein the epoxidized oil comprises is epoxidized soybean oil.

15. The curable coating system of claim 14, wherein the epoxidized soybean oil is 100%-epoxidized soybean oil.

16. The curable coating system of claim 1, wherein the first composition comprises: 20 v/v % to 45 v/v % bisphenol A-epoxide polymer,
0.2 v/v % to 0.4 v/v % siloxane polymer,
4 v/v % to 8 v/v % hydroxide salt, and
55 v/v % to 80 v/v % carbonate salt.

17. The curable coating system of claim 1, wherein the first composition comprises: 25 v/v % to 35 v/v % bisphenol A-epoxide polymer,
0.25 v/v % to 0.35 v/v % siloxane polymer,
5 v/v % to 7 v/v % hydroxide salt, and
64 v/v % to 76 v/v % carbonate salt.

18. The curable coating system of claim 1, wherein the first composition comprises:
about 29 v/v % bisphenol A-epoxide polymer,
about 0.20 v/v % to 0.40 v/v % siloxane polymer,
about 6 v/v % hydroxide salt, and
about 65 v/v % carbonate salt.

19. The curable coating system of claim 1, wherein the second component comprises: 15 v/v % to 45 v/v % first cyclic diamine,
8 v/v % to 22 v/v % second cyclic diamine,
18 v/v % to 40 v/v % phenol, and
15 v/v % to 30 v/v % alcohol different from the phenol comprising one or more aromatic groups.

20. The curable coating system of claim 1, wherein the second component comprises: 25 v/v % to 35 v/v % first cyclic diamine,
12 v/v % to 18 v/v % second cyclic diamine,
22 v/v % to 32 v/v % phenol, and
20 v/v % to 25 v/v % alcohol different from the phenol comprising one or more aromatic groups.

21.-89. (canceled)
